(19) United States
(12) Patent Application Publication
(10) Pub. No.: US 2026/0228483 A1
(43) Pub. Date: Aug. 6, 2026

(54) SYSTEM AND METHOD FOR DYNAMICALLY IMPLEMENTING ADJUSTED FORECASTING ALGORITHMS IN AN APPLICATION PROVIDED AS A SERVICE TO TENANTS, IN A MULTI-TENANT CLOUD-BASED COMPUTING ENVIRONMENT

(71) Applicant: NICE LTD., Ra'anana (IL)

(72) Inventors: Shilpa SHEGAONKAR, Pune (IN); Ashutosh MISHRA, Indore (IN); Sumit URKUDE, Pune (IN)

(21) Appl. No.: 19/046,544

(22) Filed: Feb. 6, 2025

(51) Int. Cl. G06N 3/042; G06F 18/24; G06N 3/0475

(52) U.S. Cl. CPC G06N 3/042; G06F 18/24765; G06N 3/0475

(57) ABSTRACT

A computerized-system for dynamically implementing adjusted forecasting algorithms in an application, in a multi-tenant cloud-based computing environment. Processors in the computerized-system are configured to: (i) collect tenant-metadata and interactions data from each tenant and store it; (ii) operate tenant segmentation based on a calculated tenant-score and the stored interactions data to yield tenant-segments; (iii) for each tenant-segment: a. retrieve channel information and forecast parameters related to tenants in the tenant-segment; b. invoke a serverless compute service to initiate rule association generation with a data mining algorithm based on the retrieved interactions data to yield association rules; c. store the association rules; d. provide the stored association rules, the interaction data and the tenant-metadata to a LLM; e. receive from the LLM forecasting algorithms, channel preferences, and other parameters; and f. implement the received forecasting algorithms, channel preferences, and other parameters in the application for each tenant in the tenant-segment.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records but otherwise reserves all copyright rights whatsoever.

### TECHNICAL FIELD

The present disclosure relates to the field of dynamically implementing adjusted forecasting algorithms in an application provided as a service to tenants, in a multi-tenant cloud-based computing environment.

### BACKGROUND

Artificial Intelligence (AI) algorithms are implemented in many applications which are provided as a service by a Software as a Service (SaaS) provider in a cloud-based computing environment.

For example, in a Workforce Management (WFM) application that is provided by a service provider as Software as a Service (SaaS), there may be implemented various AI algorithms designed for forecasting purposes. Currently, the AI algorithms are not selected to adequately consider the specific requirements and data characteristics of each tenant.

Even though the AI algorithms are designed to handle different seasonality patterns, it is not being factored into the algorithms selection process which may result in a suboptimal forecasting performance.

Moreover, in current systems, tenants are not being grouped or segmented based on their similarities, such as industry type, data patterns, or business needs. This lack of tenant segmentation prevents the system from leveraging commonalities that could assist in algorithms selections and improve the application's forecasting accuracy.

Differences between tenants, such as varying data volumes, historical trends, and seasonality effects, are not being considered. This oversight results in a one-size-fits-all approach for the AI algorithms selection, which is ineffective for diverse tenant profiles.

Moreover, the AI algorithms which are operating in the application as a service are not being applied correctly in the application. The algorithms selection process does not align the application's AI models' strengths with the tenants' specific forecasting requirements, leading to inaccurate forecasts. The system does not adapt to changes in tenant data or evolving business needs, resulting in outdated or irrelevant model applications.

The incorrect algorithm selection and application of AI algorithms may result in inaccurate performance of the application, such as inaccurate forecasts, which can negatively impact workforce planning and operational efficiency. Tenants of the service provider may be dissatisfied with the forecasting performance of the application, as it does not meet their specific needs or account for their unique data characteristics and seasonality patterns.

Additionally, computer resources are not being utilized effectively, as the potential of the AI algorithms is not fully realized, which may result in wasted computational power and time.

Furthermore, in current systems there are no clear guidelines or criteria for selecting the application's most suitable AI algorithms based on customer-specific factors. The current process in current systems does not involve thorough analysis of tenant data to determine the most appropriate forecasting model, and the system operates on a static approach rather than dynamically adapting to changes in customer data and requirements.

Therefore, there is a need for a technical solution for dynamically implementing adjusted forecasting algorithms in an application provided as a service to tenants, in a multi-tenant cloud-based computing environment.

### SUMMARY

There is thus provided, in accordance with some embodiments of the present disclosure, a computerized-method for dynamically implementing adjusted forecasting algorithms in an application provided as a service to tenants, in a multi-tenant cloud-based computing environment.

Furthermore, in accordance with some embodiments of the present disclosure, the computerized-system may include a tenant-metadata database; an interactions data database; an association rules database; a memory to store the plurality of databases and one or more processors.

Furthermore, in accordance with some embodiments of the present disclosure, the one or more processors may be configured to: (i) collect tenant-metadata and interactions data from each tenant in the multi-tenant cloud-based computing environment; (ii) store the tenant-metadata collected from each tenant in the tenant-metadata database and the interactions data in the interactions data database; (iii) operate tenant segmentation based on a calculated tenant-score and the stored interactions data to yield one or more tenant-segments; (iv) for each tenant-segment in the one or more tenant-segments: a. retrieve channel information and forecast parameters related to tenants in the tenant-segment from the interactions data database; b. invoke a serverless compute service to initiate rule association generation with a data mining algorithm based on the retrieved interactions data to yield association rules; c. store the association rules in the association rules database; d. provide the stored association rules, the interaction data and the tenant-metadata to a Large Language Model (LLM) and configure the LLM to interact with the association rules database based on the tenant-metadata; e. receive from the LLM forecasting algorithms, channel preferences, and other parameters; and f. implement the received forecasting algorithms, channel preferences, and other parameters in the application provided as a service for each tenant in the tenant-segment; and (v) repeat operations (i)-(iv) every preconfigured period of time to adapt to changing tenant-score and requirements.

Furthermore, in accordance with some embodiments of the present disclosure, the tenant-score may be calculated based on periodically updated one or more parameters and related weights, and the periodically updated one or more parameters may be at least one of: (i) demographics; (ii) preferences; (iii) service usage; (iv) domain; (v) license type; and (vi) tenant size.

Furthermore, in accordance with some embodiments of the present disclosure, the application may be a Workforce Management (WFM) application that is used for staff forecasting and scheduling in a contact center and the other parameters are staffing parameters.

Furthermore, in accordance with some embodiments of the present disclosure, the collecting of tenant-metadata and interactions data may further include data preprocessing of the collected tenant-metadata and interactions data.

Furthermore, in accordance with some embodiments of the present disclosure, the operating of tenant segmentation may include: (i) grouping the tenants based on domain and demographic data by using decision tree classification algorithm to yield one or more groups; and (ii) applying a soft clustering technique clustering algorithm on the one or more groups to cluster tenants based on one or more parameters to yield the one or more tenant-segments.

Furthermore, in accordance with some embodiments of the present disclosure, when the application is provided for a new tenant, the one or more processors may be further configured to associate the new tenant to the tenant-segment in the one or more tenant-segments based on the tenant-score.

Furthermore, in accordance with some embodiments of the present disclosure, the soft clustering technique clustering algorithm may be one of: Fuzzy C-Means and Gaussian Mixture Models.

Furthermore, in accordance with some embodiments of the present disclosure, the data mining algorithm may be Frequent Pattern growth (FP-growth).

There is further provided, in accordance with some embodiments of the present disclosure, a computerized-method for dynamically implementing adjusted forecasting algorithms used in an application provided as a service to tenants, in a multi-tenant cloud-based computing environment.

Furthermore, in accordance with some embodiments of the present disclosure, the computerized-method may include: (i) collecting tenant-metadata and interactions data from each tenant in the multi-tenant cloud-based computing environment; (ii) storing the tenant-metadata collected from each tenant in a tenant-metadata database and the interactions data in an interactions data database; (iii) operating tenant segmentation based on a calculated tenant-score and the stored interaction data to yield one or more tenant-segments; (iv) for each tenant-segment in the one or more tenant-segments: a. retrieving channel information and forecast parameters related to tenants in the tenant-segment from the interactions data database; b. invoking a serverless compute service to initiate rule association generation with a data mining algorithm based on the retrieved interactions data to yield association rules; c. storing the association rules in the association rules database; d. providing the stored association rules, the interaction data and the tenant-metadata to a Large Language Model (LLM) and configuring the LLM to interact with the association rules database based on the tenant-metadata; e. receiving from the LLM forecasting algorithms, channel preferences, and other parameters; and f. implementing the received forecasting algorithms, channel preferences, and other parameters in the application provided as a service for each tenant in the tenant-segment; and (v) repeating operations (i)-(iv) every preconfigured period of time to adapt to changing tenant-score and requirements.

### BRIEF DESCRIPTION OF THE DRAWINGS

FIG. 1 schematically illustrates a high-level diagram of a system for dynamically implementing adjusted forecasting algorithms in an application provided as a service to tenants, in a multi-tenant cloud-based computing environment, in accordance with some embodiments of the present disclosure;

FIGS. 2A-2B are a high-level workflow of a computerized-method for dynamically implementing adjusted forecasting algorithms in an application provided as a service to tenants, in a multi-tenant cloud-based computing environment, in accordance with some embodiments of the present disclosure;

FIG. 3 is a high-level workflow of dynamically implementing adjusted forecasting algorithms in a Workforce Management (WFM) application provided as a service to tenants, in a multi-tenant cloud-based computing environment, in accordance with some embodiments of the present disclosure;

FIGS. 4A-4B are a high-level workflow of dynamically implementing adjusted forecasting algorithms in a Workforce Management (WFM) application provided as a service to tenants, in a multi-tenant cloud-based computing environment, in accordance with some embodiments of the present disclosure;

FIG. 5 schematically illustrates a high-level diagram of segmentation of tenants of a service provider in a multi-tenant cloud-based computing environment, in accordance with some embodiments of the present disclosure;

FIG. 6 schematically illustrates a high-level diagram of parameters used to calculate a tenant-score for segmentation tenants of a service provider in a multi-tenant cloud-based computing environment, in accordance with some embodiments of the present disclosure;

FIG. 7 is a high-level workflow of segmentation of tenants of a service provider in a multi-tenant cloud-based computing environment, in accordance with some embodiments of the present disclosure;

FIG. 8 is a high-level workflow of tenant-metadata and interactions data collection from each tenant in the multi-tenant cloud-based computing environment for tenant-score calculation, in accordance with some embodiments of the present disclosure;

FIG. 9 is a high-level workflow of tenant-metadata and interactions data collection from each tenant in the multi-tenant cloud-based computing environment for tenant-score calculation and tenant segmentation, in accordance with some embodiments of the present disclosure;

FIG. 10 is a high-level workflow of tenant segmentation, in accordance with some embodiments of the present disclosure;

FIG. 11 is a high-level workflow of refining tenant segmentation, in accordance with some embodiments of the present disclosure;

FIG. 12 is a high-level workflow of refining tenant segmentation every preconfigured period of time to adapt to changing tenant-score and requirements, in accordance with some embodiments of the present disclosure;

FIG. 13 is a high-level workflow of recommendation generation based on tenant-metadata and interactions data, in accordance with some embodiments of the present disclosure;

FIG. 14 is a high-level workflow of forecast recommendation generation based on tenant-metadata and interactions data, in accordance with some embodiments of the present disclosure;

FIG. 15 is an example of a User Interface (UI) to define segmentation parameters, in accordance with some embodiments of the present disclosure;

FIG. 16 is an example of a UI for forecasting segmentation, in accordance with some embodiments of the present disclosure;

FIG. 17A-17B are examples of a UI to interact via bot conversation to enhance forecasting segmentation, in accordance with some embodiments of the present disclosure; and

FIGS. 18A-18C is an example of forecasting without tenant segmentation and with tenant segmentation, according to some embodiments of the present disclosure.

### DETAILED DESCRIPTION

In the following detailed description, numerous specific details are set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

In current applications which are provided as a service to tenants, in a multi-tenant cloud-based computing environment there are various distinct AI algorithms designated for forecasting purposes. For example, Workforce Management (WFM) application. These AI algorithms are meant to be tailored to accommodate various types of customer, e.g., tenant needs, data characteristics, and seasonality patterns. However, the current implementation fails to achieve this goal effectively.

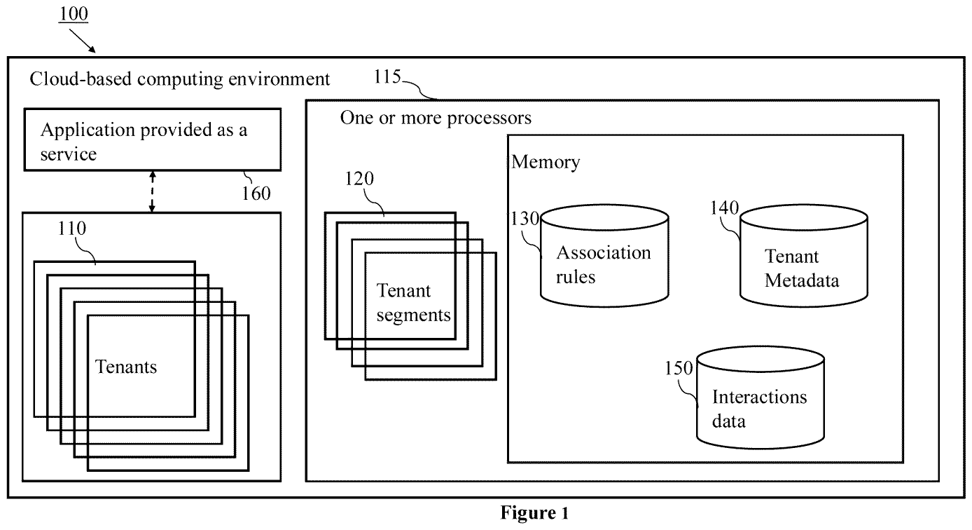

FIG. 1 schematically illustrates a high-level diagram of a system 100 for dynamically implementing adjusted forecasting algorithms in an application that is provided as a service to tenants, in a multi-tenant cloud-based computing environment, in accordance with some embodiments of the present disclosure.

According to some embodiments of the present disclosure, a system, such as system 100 may dynamically implement one or more adjusted forecasting algorithms in an application that is provided as a service to tenants, in a multi-tenant cloud-based computing environment.

According to some embodiments of the present disclosure, selecting and tuning algorithms to match the specific requirements of the task can help improve computational efficiency. This includes using simpler models where appropriate and optimizing hyperparameters to reduce computational load. Also, using algorithms that are not well-suited for the specific task can lead to inefficiencies. For instance, a complex deep learning model might waste computer resources for a problem that could be solved with a simpler machine learning algorithm, leading to unnecessary computational overhead.

According to some embodiments of the present disclosure, a system, such as system 100 may select the most suitable algorithm for each tenant, thereby ensuring accurate and reliable forecasts via the application 160. For example, the application may be a Workforce Management (WFM) application that is used for staff forecasting and scheduling in a contact center.

According to some embodiments of the present disclosure, system 100 may include a tenant-metadata database 140, an interactions data database 150, an association rules database 130 and a memory to store the plurality of databases. One or more processors 115 may be configured to collect tenant-metadata and interactions data from each tenant of the tenants 110 in the multi-tenant cloud-based computing environment and store the tenant-metadata that has been collected from each tenant in the tenant-metadata database 140 and the interactions data in the interactions data database 150.

According to some embodiments of the present disclosure, the tenant-metadata may include parameters such as demographics, preferences, service usage, domain, license type and tenant size. The interactions data refers to the data generated when a tenant interacts with the forecasting module and may include parameters provided by the tenant while generating forecasts, such as the forecasting algorithm, selected skills, staffing parameters, special days, and other inputs. Essentially, interaction data captures how a tenant utilizes the forecasting module and the specific configurations they apply.

According to some embodiments of the present disclosure, the collecting of tenant-metadata and interactions data may further include data preprocessing of the collected tenant-metadata and interactions data.

According to some embodiments of the present disclosure, the one or more processors 115 may operate tenant segmentation of the tenants 110 based on a calculated tenant-score and the stored interactions data to yield tenant-segments 120. The tenant segmentation may be leveraged by system 100 to implement adaptive forecasting models tailored to each tenant-segment in the application that is provided as a service 160. Thus, improving the precision of forecasts operated by the application that is provided as a service 160 to each tenant of the tenants 110, even for tenants with limited historical data, as the forecasting algorithms used in the application may be selected based on the tenant-segment that the tenant relates to.

According to some embodiments of the present disclosure, the forecasting models may be for example, Autoregressive integrated moving average (ARIMA), Exponential smoothing, and Curve Fitting.

According to some embodiments of the present disclosure, the tenant-score may be calculated based on periodically updated one or more parameters and related weights. The periodically updated one or more parameters may be for example, demographics, preferences, service usage, domain, license type, and tenant size. Thus, system 100 may provide a seamless experience for tenants 110 of the service provider, even during emergency business needs. By dynamically adapting forecasting models, system 100 may enable a quick response to fluctuations in data without compromising forecasting accuracy. Moreover, the automated adaption of the forecasting models may increase efficiency and reduce errors in the application implementation.

According to some embodiments of the present disclosure, the operating of tenant segmentation may reduce manual setup for new tenants and eliminate the need for representative historical dataset which may speed up onboarding of new tenants and deliver immediate value.

According to some embodiments of the present disclosure, the operating of tenant segmentation may include grouping the tenants based on domain and demographic data by using decision tree classification algorithm to yield one or more groups, and applying a soft clustering technique clustering algorithm on the one or more groups to cluster tenants based on one or more parameters to yield the one or more tenant-segments.

According to some embodiments of the present disclosure, the soft clustering technique clustering algorithm may be for example Fuzzy C-Means or Gaussian Mixture Models.

According to some embodiments of the present disclosure, for each tenant-segment in the one or more tenant-segments, the one or more processors 115 may retrieve channel information and forecast parameters related to tenants in the tenant-segment from the interactions data database 150 and invoke a serverless compute service to initiate rule association generation with a data mining algorithm based on the retrieved interactions data to yield association rules. For example, the data mining algorithm may be Frequent Pattern growth (FP-growth).

According to some embodiments of the present disclosure, the association rules learning process may be used to identify relationships among items in large datasets, e.g., interactions data and tenant-metadata. It may find patterns, correlations, or associations that show how different items or events are related. The association rule learning is a data mining technique used to identify relationships, patterns, or associations among the set of items. For example, forecasting algorithms, channel preferences, and other parameters.

According to some embodiments of the present disclosure, the association rules may embed the tenant behavior and most suitable forecasting models, channel preferences and other parameters in the application. The algorithm selection for each tenant that is in the tenant-segment may be aligned with the tenant forecasting requirements.

According to some embodiments of the present disclosure, system 100 may continuously monitor tenants behavior e.g., tenant-metadata and interactions data and adjust the forecasting models for the application that is provided as a service 160 for each tenant of tenants 110.

According to some embodiments of the present disclosure, the one or more processors 115 may store the association rules in the association rules database 130 and provide the stored association rules, the interaction data and the tenant-metadata to a Large Language Model (LLM) and configure the LLM to interact with the association rules database 130 based on the tenant-metadata.

According to some embodiments of the present disclosure, the forecasting algorithms, channel preferences, and other parameters may be received from the LLM and may be implemented in the application that is provided as a service 160 for each tenant in the tenant-segment. For example, when the application is WFM application, then the forecasting algorithms may be used during the WFM application operation, by the tenant, to generate a schedule for the agents for a specified period as well as staffing parameters, such as Average Speed of Answer (ASA), Service Level (SL), and maximum occupancy. The channel preferences may be embedded in the generated schedule of agents shifts.

According to some embodiments of the present disclosure, system 100 may operate dynamically to adapt to changing tenant data and requirements. By continuously monitoring and updating tenant-segmentation criteria, system 100 may ensure alignment with current trends and behaviors.

According to some embodiments of the present disclosure, when the application 160 is provided for a new tenant, the one or more processors 115 may be further configured to associate the new tenant to the tenant-segment in the one or more tenant-segments based on a calculation of the tenant-score.

According to some embodiments of the present disclosure, system 100 may not only group tenants by similar characteristics but may also map specific forecasting algorithms to each tenant-segment to ensure higher forecast accuracy by addressing the unique characteristics of each customer group.

According to some embodiments of the present disclosure, system 100 may repeatedly segment tenants and select forecasting algorithms, channel preferences, and other parameters every preconfigured period of time to adapt to changing tenant-score and requirements.

According to some embodiments of the present disclosure, for example, a healthcare provider from the USA with a medium-sized operation, subscribing for 1 year, using English as the language, and selecting the Advance license. The input to the LLM may be numerically encoded as (5,5,6,3,2,4). Based on the output of the LLM the new customer is advised to focus on WhatsApp and Email channels, using the ARIMA forecasting algorithm with durations of 1 month and 1 year, and plan for campaigns around Christmas and Black Friday. These Channels and Model information are being extracted based on the response that LLM received from the association rule generation.

According to some embodiments of the present disclosure, the LLM may use the concept of Retrieval Augmented Generation (RAG) to connect to external modules. It may initially understand the user's intent and may convey this context to the rule association generation. Once the rule association generation provides additional information, the LLM may incorporate the retrieved knowledge into its response, ensuring that the output is both generative and grounded in accurate, up-to-date, or domain-specific information.

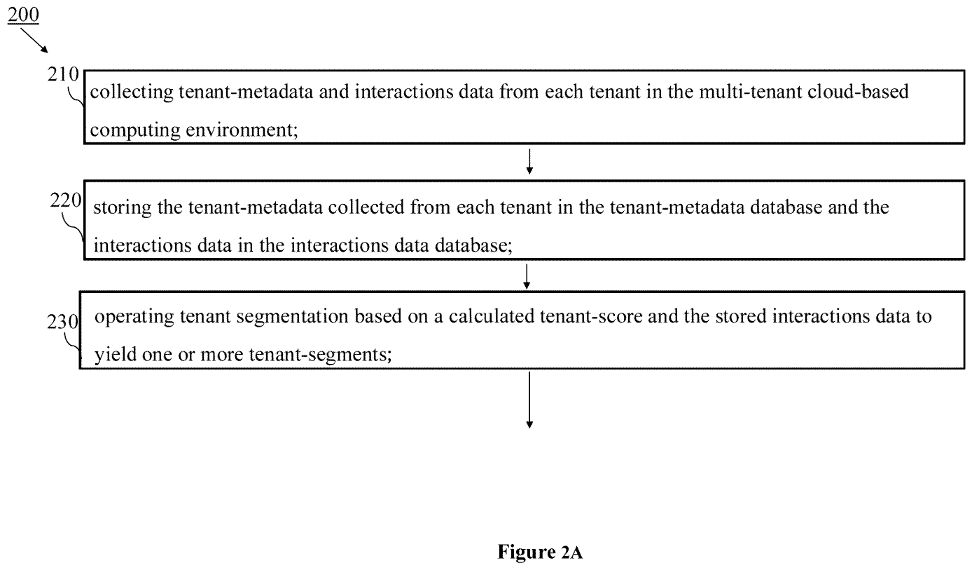

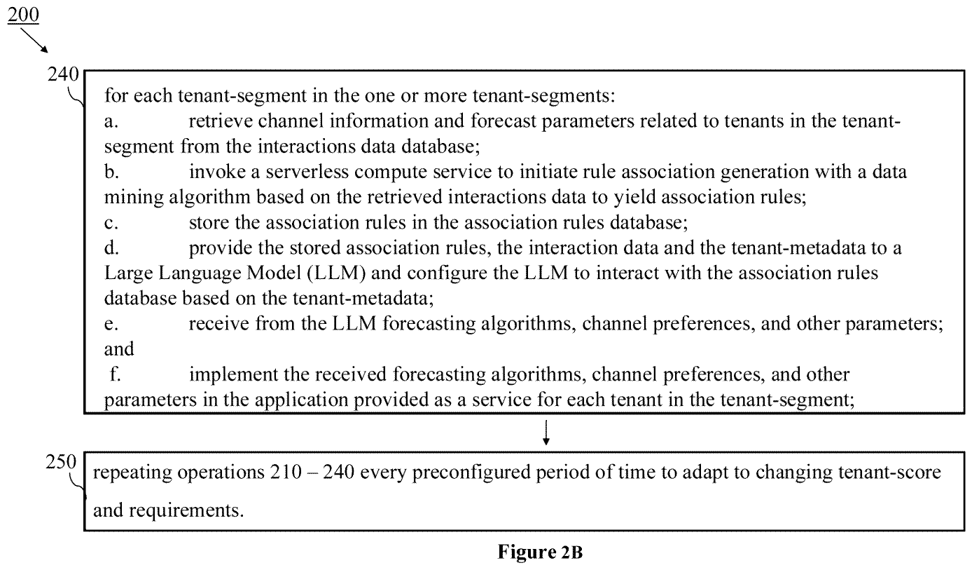

FIGS. 2A-2B are a high-level workflow 200 of a computerized-method for dynamically implementing adjusted forecasting algorithms in an application provided as a service to tenants, in a multi-tenant cloud-based computing environment, in accordance with some embodiments of the present disclosure.

According to some embodiments of the present disclosure, operation 210 comprising collecting tenant-metadata and interactions data from each tenant in the multi-tenant cloud-based computing environment.

According to some embodiments of the present disclosure, operation 220 comprising storing the tenant-metadata collected from each tenant in the tenant-metadata database and the interactions data in the interactions data database.

According to some embodiments of the present disclosure, operation 230 comprising operating tenant segmentation based on a calculated tenant-score and the stored interactions data to yield one or more tenant-segments.

According to some embodiments of the present disclosure, operation 240 comprising for each tenant-segment in the one or more tenant-segments: a. retrieve channel information and forecast parameters related to tenants in the tenant-segment from the interactions data database; b. invoke a serverless compute service to initiate rule association generation with a data mining algorithm based on the retrieved interactions data to yield association rules; c. store the association rules in the association rules database; d. provide the stored association rules, the interaction data and the tenant-metadata to a Large Language Model (LLM) and configure the LLM to interact with the association rules database based on the tenant-metadata; e. receiving from the LLM forecasting algorithms, channel preferences, and other parameters; f. implementing the received forecasting algorithms, channel preferences, and other parameters in the application provided as a service for each tenant in the tenant-segment.

According to some embodiments of the present disclosure, operation 250 comprising repeating operations 210-240 every preconfigured period of time to adapt to changing tenant-score and requirements.

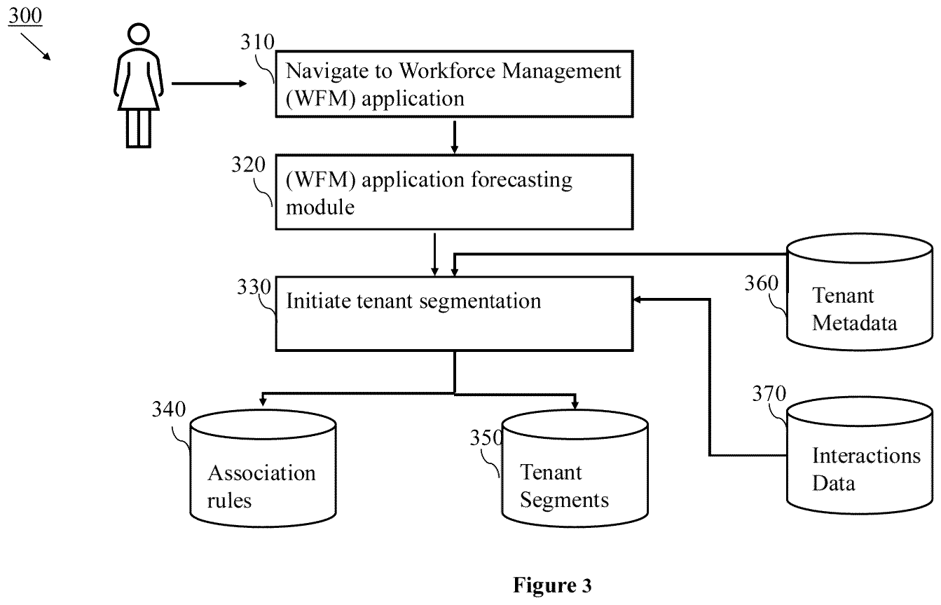

FIG. 3 is a high-level workflow 300 of dynamically implementing adjusted forecasting algorithms in a Workforce Management (WFM) application provided as a service to tenants, in a multi-tenant cloud-based computing environment, in accordance with some embodiments of the present disclosure.

According to some embodiments of the present disclosure, in a system, such as system 100 in FIG. 1, a user of a cloud-based computing environment may access an application, such as application 160 in FIG. 1. The application may be for example, WFM application and the user may navigate to it 310. The user may enter a module within the WFM application that operates forecasting and prepares segmentation tasks 320.

According to some embodiments of the present disclosure, the module may initiate tenant segmentation 330 based on data sources, e.g., tenant metadata database 360 and interaction data database 370. The tenant-metadata retrieved from the tenant-metadata database 360 may be used to provide contextual insights for the tenant segmentation process. The interactions data retrieved from the interactions data database 370 may include interaction records which may be used to identify behavioral patterns and trends.

According to some embodiments of the present disclosure, for example, the following data may be retrieved from tenant metadata database:

```
{
  “tenantId” : “11e8d905-e402-4ce0-ac75-0242ac110004”,
  “tenantName” : “perm_Pune_Storage”,
  “schemaName” : “perm_Pune_Storage”,
  “parentId” : “11ebb752-96b9-c390-9b24-0242ac110002”,
  “partnerId” : “11e92ea3-519a-89a0-bcb9-0242ac110006”,
  “source” : “tm-webapp”,
  “creationDate” : “2018-10-26T10:00:03.646+00:00”,
  “expirationDate” : “3000-01-01T00:00:00.000+00:00”,
  “timezone” : “Asia/Bangkok”,
  “status” : “ACTIVE”,
  “type” : “CUSTOMER”,
  customerType″ : “BASIC”,
  “clusterId” : “TO31”,
  “billingId” : “1118000934”,
  “userSoftLimit” : 500,
  “tenantDeletionInfo” : null,
  “errorCode” : null,
  “processingStartDate” : “2025-01-31T09:17:20.864+00:00”,
  “systemType” : “CXONE”,
  “partnerName” : “perm_audit_branding_partner”,
  “lineOfBusiness” : xyz,
  “industryType” : null
}
```

According to some embodiments of the present disclosure, the tenant segmentation process may be operated based on a calculated tenant-score and the interactions data to yield tenant-segments, which may be stored in tenant segments database 350. For each tenant-segment in the tenant-segments channel information and forecast parameters related to tenants in the tenant segment may be retrieved from the interactions data database 370 and then a serverless compute service may be invoked to initiate rule association generation with a data mining algorithm based on the retrieved interactions data to yield association rules.

According to some embodiments of the present disclosure, the association rules may be stored in association rules database 340.

According to some embodiments of the present disclosure, the stored association rules of the tenant-segment in the association rules database 340 the interaction data and the tenant-metadata may be provided to a Large Language Model (LLM) which may be configured to interact with the association rules database 340 based on the tenant-metadata.

According to some embodiments of the present disclosure, the LLM may provide forecasting algorithms, channel preferences, and other parameters for the tenant-segment.

According to some embodiments of the present disclosure, the provided forecasting algorithms, channel preferences, and other parameters, such as staffing parameters, may be implemented in the application that is provided as a service, such as application 160 in FIG. 1, for each tenant in the tenant-segment during the operation of the application.

According to some embodiments of the present disclosure, the tenant segmentation process and forecasting algorithms, channel preferences, and other parameters provided by the LLM may be operated every preconfigured period of time to adapt to changing tenant-score and requirements.

According to some embodiments of the present disclosure, the requirements are changing as the parameters used in forecasting are not static. Customers, e.g., tenants may alter these parameters based on their evolving needs or changing circumstances. There may be a change in forecast algorithm used, channels, seasonality patterns and special days preferences, etc.

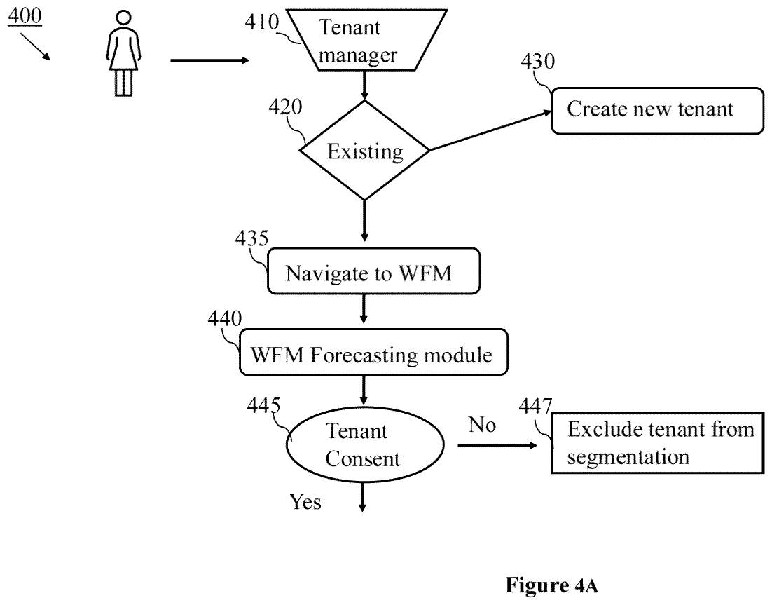

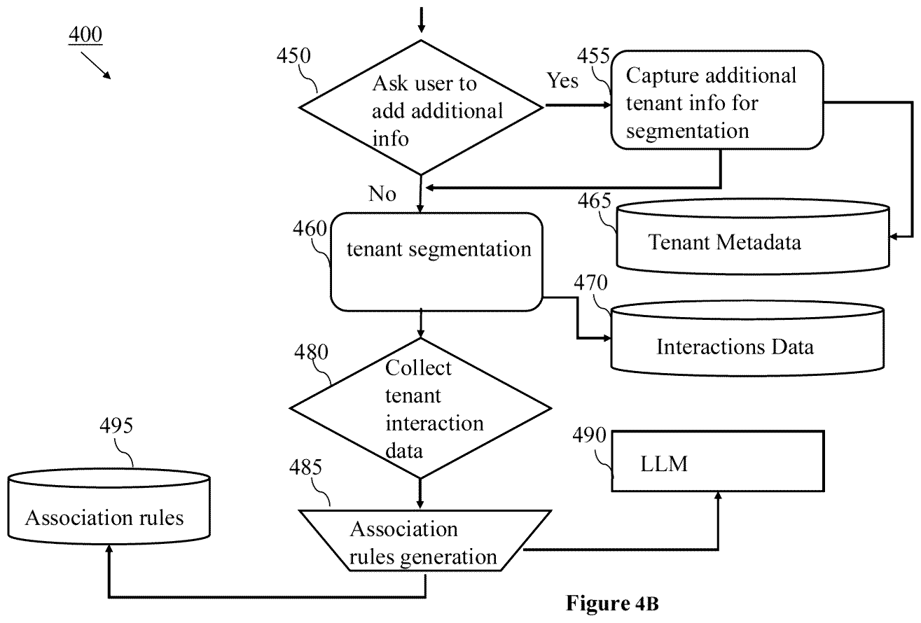

FIGS. 4A-4B is a high-level workflow 400 of dynamically implementing adjusted forecasting algorithms in a Workforce Management (WFM) application provided as a service to tenants, in a multi-tenant cloud-based computing environment, in accordance with some embodiments of the present disclosure.

According to some embodiments of the present disclosure, a system, such as system 100 in FIG. 1 may be implemented to leverage LLM to provide recommendations based on tenant data, interactions insights and knowledge base.

According to some embodiments of the present disclosure, optionally, a user may access a tenant manager module 410 which may manage and navigate tenant information. For each tenant, it may be determined if the tenant exists in the system 420. In case the tenant doesn't exist in the system, a new tenant may be created 430 for the application, such as application 160 in FIG. 1. Otherwise, navigating to the application, such as application 160 in FIG. 1, and such as WFM application 435.

According to some embodiments of the present disclosure, optionally, navigating to the forecasting module in the WFM application 440 and then checking for tenant consent 445 for tenant segmentation. In case the tenant didn't consent for the tenant segmentation process, the tenant may be excluded from segmentation 447. Otherwise, if the tenant has provided consent for tenant segmentation, then the new tenant may be associated to the tenant-segment in the one or more tenant-segments based on the tenant-score.

According to some embodiments of the present disclosure, optionally, the user may be asked to add additional information 450. In case the user has entered additional information, the additional tenant information may be captured for segmentation 455 and stored in tenant metadata database 465.

According to some embodiments of the present disclosure, tenant segmentation 460 may be operated based on collected tenant interaction data 480 from the interactions data database 470.

According to some embodiments of the present disclosure, association rules may be generated 485 by a serverless compute service with a data mining algorithm based on the retrieved interactions data and stored in an association rules database 495.

According to some embodiments of the present disclosure, the stored rules may be provided to a LLM 490 which may be configured to interact with the association rules database 495 based on the tenant-metadata. The LLM may provide forecasting algorithms, channel preferences, and other parameters.

According to some embodiments of the present disclosure, the received forecasting algorithms, channel preferences, and other parameters from the LLM may be implemented in the application provided as a service, such as application 160 in FIG. 1, for each tenant in the tenant-segment.

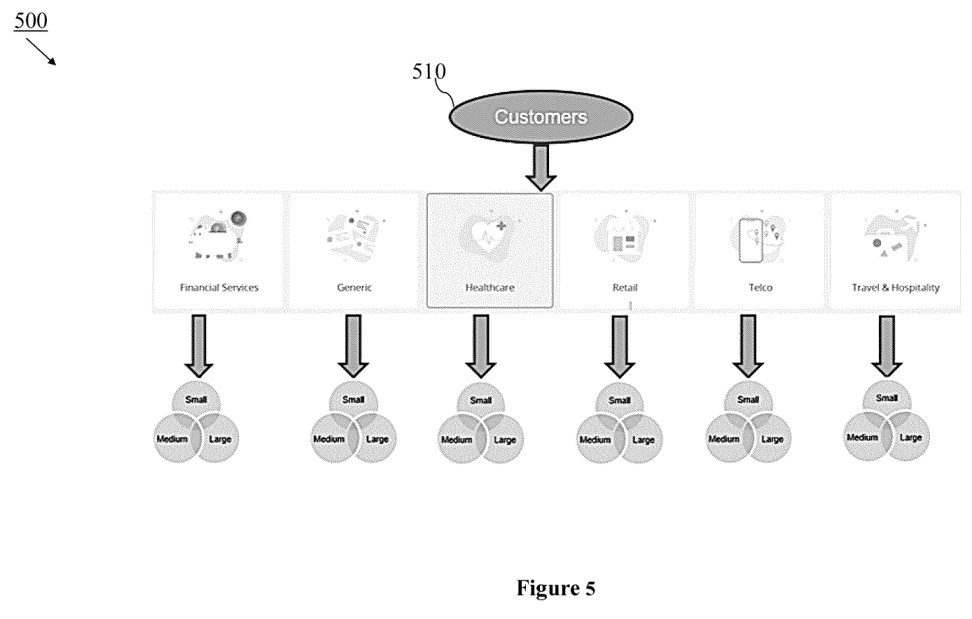

FIG. 5 schematically illustrates a high-level diagram 500 of segmentation of tenants of a service provider in a multi-tenant cloud-based computing environment, in accordance with some embodiments of the present disclosure.

According to some embodiments of the present disclosure, in a system, such as system 100 in FIG. 1, tenant segmentation for customers 510, e.g. tenant 110 in FIG. 1, may be operated based on a calculated tenant-score and the stored interactions data to yield one or more tenant-segments. The tenant-score may be calculated based on periodically updated one or more parameters and related weights, and the periodically updated one or more parameters may be for example, demographics, preferences, service usage, domain, license type, and tenant size.

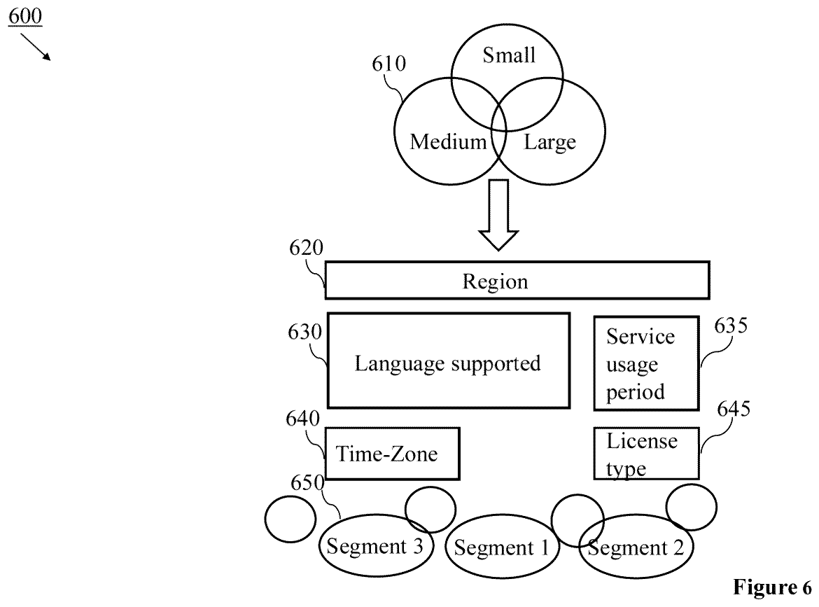

According to some embodiments of the present disclosure, the tenant segmentation process may be operated for each tenant industry, such as financial services, generic, healthcare, retail, telco and travel and hospitality. Each tenant industry segment may be further classified into tenant size, for example, small, medium and large, as shown in FIG. 6

According to some embodiments of the present disclosure, the operating of tenant segmentation may include grouping the tenants based on domain and demographic data by using decision tree classification algorithm to yield one or more groups and applying a soft clustering technique clustering algorithm on the one or more groups to cluster tenants based on one or more parameters to yield the one or more tenant-segments.

According to some embodiments of the present disclosure, the soft clustering technique clustering algorithm may be for example, Fuzzy C-Means or Gaussian Mixture Models.

FIG. 6 schematically illustrates a high-level diagram 600 of parameters used to calculate a tenant-score for segmentation tenants of a service provider in a multi-tenant cloud-based computing environment, in accordance with some embodiments of the present disclosure.

According to some embodiments of the present disclosure, in a system, such as system 100 in FIG. 1, the tenant segmentation framework organizes tenants, such as tenants 110 in FIG. 1, into distinct segments, e.g., Segment1, Segment2, Segment3 650, based on shared characteristics. This granular approach enables more targeted solutions, tailored services, and optimized resource allocation, ensuring better alignment with tenant needs and improving overall service efficiency.

According to some embodiments of the present disclosure, the tenant-score may be calculated based on periodically updated parameters and related weights. The periodically updated parameters may be for example, region 620, preferences, such as language supported 630, service usage period 635, domain, license type 645, tenant size, and time zone.

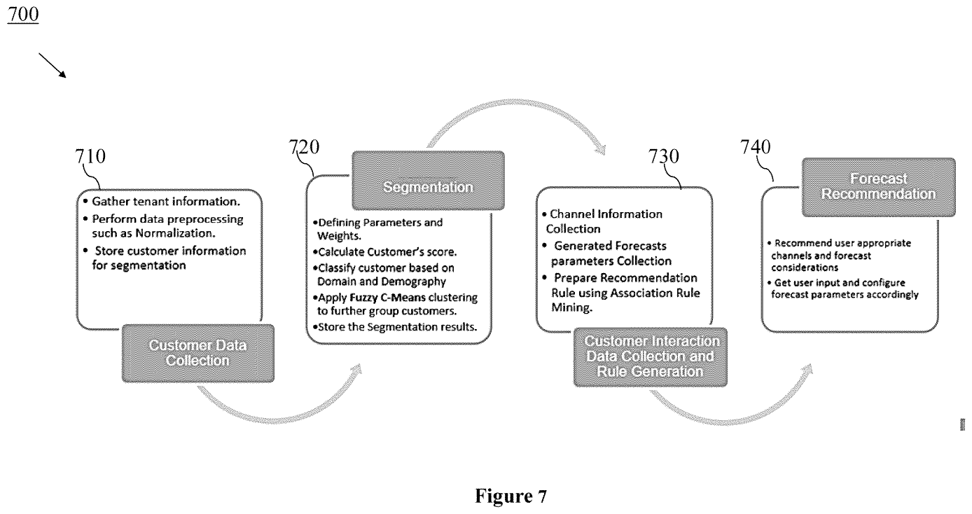

FIG. 7 is a high-level workflow 700 of segmentation of tenants of a service provider in a multi-tenant cloud-based computing environment, in accordance with some embodiments of the present disclosure.

According to some embodiments of the present disclosure, in a system, such as system 100 in FIG. 1, adjusted forecasting algorithms may be implemented in an application that is provided as a service to tenants, such as application 160, in FIG. 1, in a multi-tenant cloud-based computing environment.

According to some embodiments of the present disclosure, tenant segmentation 720 may be operated by defining tenant related parameters, such as demographics, preferences, service usage, domain, license type and tenant size and related weights to calculate tenant-score and then classifying customers, e.g., grouping tenants, based on domain and demography by using decision tree classification algorithm to yield one or more groups. A soft clustering technique clustering algorithm, such as Fuzzy C-Means and such as Gaussian Mixture Models, may be applied on the one or more groups to cluster tenants, such as tenants 110 in FIG. 1, based on the parameters to yield the tenant-segments. The segmentation results may be stored in a database.

According to some embodiments of the present disclosure, a serverless compute service may be invoked to initiate rule association generation with a data mining algorithm based on the retrieved interactions data to yield association rules 730.

According to some embodiments of the present disclosure, the association rules may be stored in an association rules database, such as association rules database 130 in FIG. 1, and may be provided to a LLM with interaction data and tenant-metadata to interact with the association rules database based on the tenant-metadata. The LLM may process the association rules and interaction data and tenant-metadata and provide forecasting algorithms, channel preferences, and other parameters.

According to some embodiments of the present disclosure, forecast recommendation 740 may include forecasting algorithms, channel preferences, and other parameters implemented in the application provided as a service, such as application 160 in FIG. 1, for each tenant in the tenant-segment. Optionally, when the collecting customer information may be initiated, the bot such as Enlighten autopilot may ask customers for inputs which may aid in driving customers into more refined groups and tenant segments.

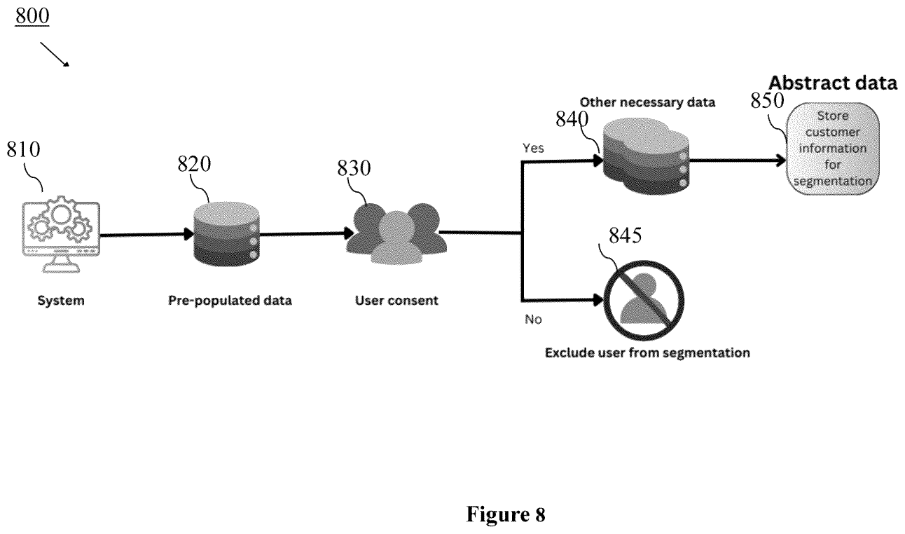

FIG. 8 is a high-level workflow 800 of tenant-metadata and interactions data collection from each tenant in the multi-tenant cloud-based computing environment for tenant-score calculation, in accordance with some embodiments of the present disclosure.

According to some embodiments of the present disclosure, a system 810, such as system 100 in FIG. 1, may retrieve prepopulated data 820 related to tenants, such as tenants 110 in FIG. 1. The prepopulated data may be tenant metadata and interactions data.

According to some embodiments of the present disclosure, optionally, tenants of a service provider of an application that is provided as a service, such as application 160 in FIG. 1, may be prompted to provide consent 830 for data usage for tenant segmentation and recommendations thereupon. When the consent is given, additional necessary data 840 may be collected and aggregated with the prepopulated data.

According to some embodiments of the present disclosure, when a tenant doesn't provide consent for tenant segmentation, the tenant is excluded from the tenant segmentation process 845.

According to some embodiments of the present disclosure, abstract data 850 may be stored for tenant segmentation purposes. The abstract data may include tenant related data, such as domain, demography, and tenant size.

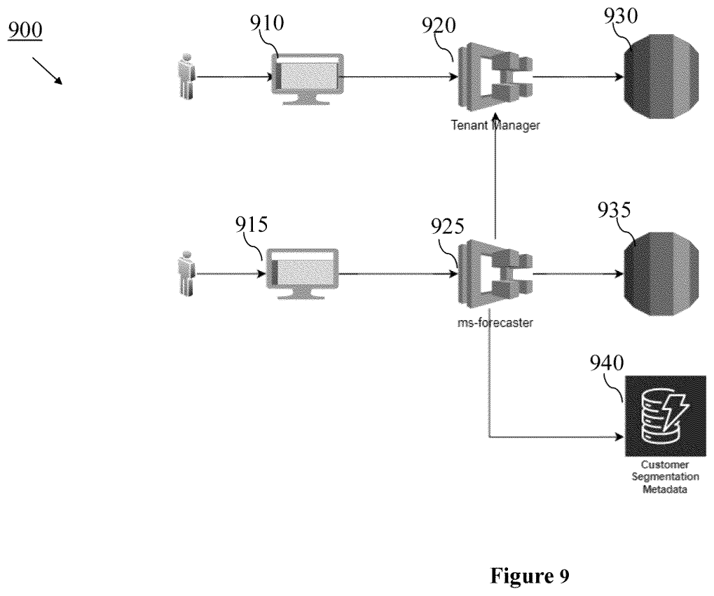

FIG. 9 is a high-level workflow 900 of tenant-metadata and interactions data collection from each tenant in the multi-tenant cloud-based computing environment for tenant-score calculation and tenant segmentation, in accordance with some embodiments of the present disclosure.

According to some embodiments of the present disclosure, optionally, a user may enter a platform of the service provider of the application as a service in the cloud-computing environment, 910, 915 for tenant-related workflows. The user may provide inputs or access the platform to manage tenant-related configurations and data. The platform may be a cloud-based Customer Experience (CX) platform designed to manage voice and digital interactions across customer journeys which delivers customer experiences through multiple channels and touchpoints.

According to some embodiments of the present disclosure, optionally, the user may navigate to tenant manager module 920 for managing tenant-specific information. The tenant manager microservice 920 may interact with a database, such as Amazon Web Service (AWS) Relational Database Service (RDS) to store and retrieve tenant-related data securely. Tenant related information such as demography, size of customer, license, preferred channels, service used and domain. The tenant manager microservice 920 may ensure that all tenant metadata is updated and accessible for downstream workflows.

According to some embodiments of the present disclosure, the tenant manager microservice 920 may act as the central hub for managing tenant lifecycle data within the system.

According to some embodiments of the present disclosure, the forecaster microservice 925 may be a tool of the platform used to create an optimal staffing plan. The forecaster microservice 925 may fetch tenant information from the tenant manager microservice 920 for further processing, as well as ensure tenant consent for segmentation and processes confirmation data before passing it for segmentation workflows.

According to some embodiments of the present disclosure, two types of information may be used for segmentation: Personal Identifiable Information (PII) and non PII. The PII information of the tenant, such as tenant id and tenant name, may be retrieved from tenant manager microservice 920 and may be stored in the application database 930. The non PII data, such as domain, demography and interactions data, may be collected from the tenant and may be stored in another database, such as DynamoDB (DDB).

According to some embodiments of the present disclosure, the forecaster microservice 925 may preprocess the tenant-metadata, for example, normalizing the data by converting categorical information into its numerical representation and data cleanup by handling null along outlier.

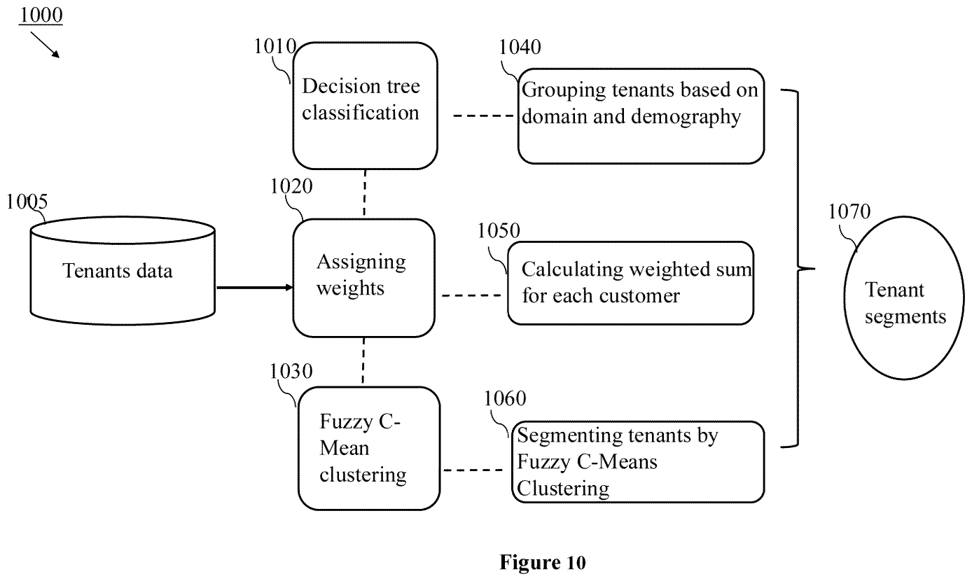

FIG. 10 is a high-level workflow 1000 of tenant segmentation, in accordance with some embodiments of the present disclosure.

According to some embodiments of the present disclosure, a system, such as system 100 in FIG. 1, may read abstract data, such as abstract data 850 in FIG. 8, from the tenant database 1005.

According to some embodiments of the present disclosure, tenants may be classified to groups based on predefined parameters, such as domain and demographic information, by using decision tree classification 1010 for grouping tenants based on the parameters 1040, e.g. domain and demography.

According to some embodiments of the present disclosure, assigning weights to parameters 1020 for a weighted sum may be calculated for each tenant 1050 based on specific attributes or factors relevant to their profile. The weighted sum ensures that tenants are prioritized or grouped according to their significance in the data.

According to some embodiments of the present disclosure, a soft clustering technique clustering algorithm may be applied on the groups to cluster tenants 1060 based on one or more parameters to yield the tenant-segments 1070. The soft clustering technique clustering algorithm may be for example, Fuzzy C-Means clustering 1030 and Gaussian Mixture Models.

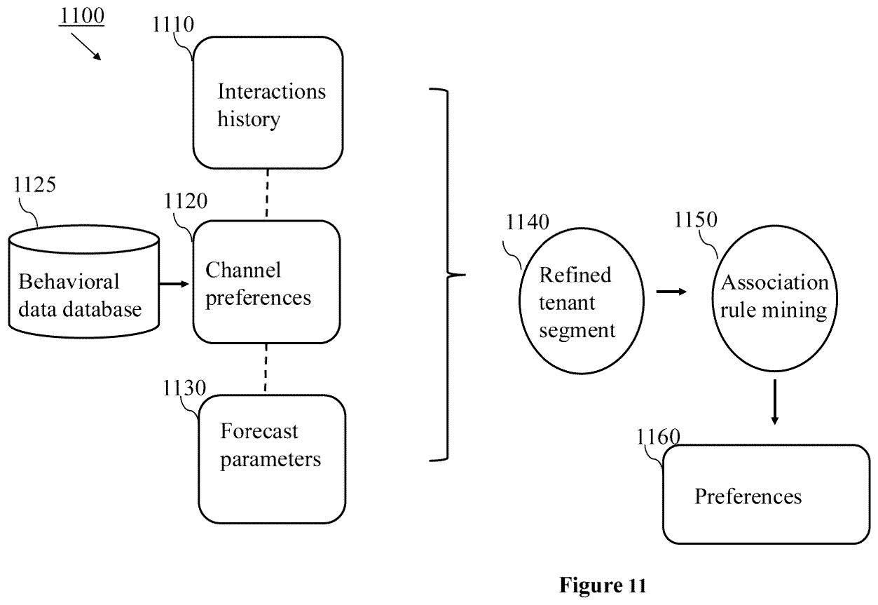

FIG. 11 is a high-level workflow 1100 of refining tenant segmentation, in accordance with some embodiments of the present disclosure.

According to some embodiments of the present disclosure, in a system, such as system 100 in FIG. 1, an Extract Transform Load (ETL) process may be used to retrieve and preprocess tenant interaction and behavioral data such as interaction data, and service usage from the database 1125.

According to some embodiments of the present disclosure, channel preferences 1120, e.g., tenant preferences may be identified for communication or service delivery channels based on interactions history 1110 and related behaviors.

According to some embodiments of the present disclosure, forecasting parameters 1130 which are key parameters that influence forecasting, such as usage patterns and service history, may be extracted to support tenant segmentation and decision-making.

According to some embodiments of the present disclosure, using the behavioral data, the system may refine the previously generated tenant segments 1140, ensuring they align more closely with observed tenant actions and preferences.

According to some embodiments of the present disclosure, the refined tenant segments 1140 may be analyzed for association rule mining 1150 by using the data mining algorithm is Frequent Pattern growth (FP-growth) to identify hidden patterns and relationships within the data. These insights help generate actionable rules and recommendations.

According to some embodiments of the present disclosure, based on the analysis, tenant preferences 1160 may be documented. These preferences guide the system in making targeted recommendations for communication, service, or forecasting parameters.

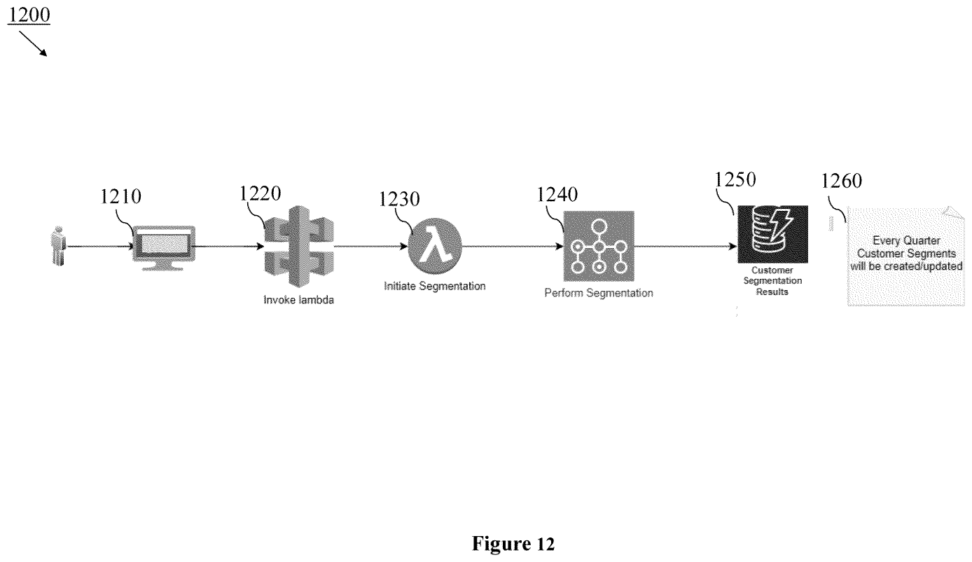

FIG. 12 is a high-level workflow 1200 of refining tenant segmentation every preconfigured period of time to adapt to changing tenant-score and requirements, in accordance with some embodiments of the present disclosure.

According to some embodiments of the present disclosure, optionally a user may enter a platform to manage forecasting in the application 1210.

According to some embodiments of the present disclosure, the process of dynamically implementing adjusted forecasting algorithms in an application provided as a service to tenants, such as application 160 in FIG. 1, in a multi-tenant cloud-based computing environment, as operated by system 100 in FIG. 1, may be triggered every preconfigured period of time. For example, an AWS CloudWatch Event or EventBridge Rule may trigger the workflow every quarter to process the collected customer information. Thus, keeping tenant segmentation up-to-date and aligned with recent data

According to some embodiments of the present disclosure, AWS Lambda 1220 may initiate segmentation 1230. The AWS Lambda 1220 may validate input data and may trigger an AWS Batch job that processes tenant segmentation in multiple stages.

According to some embodiments of the present disclosure, the AWS Batch job orchestrates the tenant segmentation process 1240, and may include the following.

According to some embodiments of the present disclosure, normalized tenant data may be retrieved from tenant metadata database, such as tenant metadata database 140 in FIG. 1, which may be implemented by AWS RDS or DynamoDB. The database may include attributes like domain, demographics, engagement levels, and preference, for example, as shown in FIG. 6.

According to some embodiments of the present disclosure, tenants may be assigned weights based on specific attributes or factors that define their significance. The weight assignment operation may be used as a foundation for the clustering and the tenant segmentation. Domain, e.g., healthcare, finance, and importance may be assigned based on industry impact. Demographics, e.g., USA, Europe, geographic weight adjustments which is the weight assigned to tenants based on their geographic location, possibly to account for regional differences in demand or business context. The engagement level may be frequency or recency of tenant activity.

According to some embodiments of the present disclosure, the revenue potential may be adjusted a weight for tenants with higher revenue contributions.

According to some embodiments of the present disclosure, weights may be assigned based on domain knowledge, or using methods such as, Principal Component Analysis (PCA) to determine the variance explained by each feature and assign weights accordingly, expert judgment may be based on business priorities, and Analytic Hierarchy Process (AHP) to systematically assign weights based on pairwise comparisons.

According to some embodiments of the present disclosure, for example, for tenant ID C001 demographic 0.75, preferences 0.60, domain 0.80, size 0.50, profit 0.85, usage 0.70 and tenant-score 0.75. A weighted tenant-score may be calculated for each tenant, which will serve as the basis for tenant segmentation. To calculate the tenant-score, a weighted sum approach may be applied. Each factor, such as demographics, preferences, service usage, and other relevant criteria, is assigned a specific weight. The tenant-score may be then determined by multiplying each factor's weight by its corresponding value.

According to some embodiments of the present disclosure, the value is determined by analyzing the context and significance of each factor in contributing to the overall customer score. Factors that are deemed more influential in determining the outcome are given higher weights, while those of lesser importance are assigned lower values.

According to some embodiments of the present disclosure, the weights may be assigned based on domain knowledge. Alternatively, the following method may be used. Principal Component Analysis (PCA) to determine the variance explained by each feature and assign weights accordingly. Expert Judgment based on business priorities. Analytic Hierarchy Process (AHP) to systematically assign weights based on pairwise comparisons and summing these products to yield the tenant-score. Essentially, the tenant-score may be the aggregate result of these weighted values, providing a comprehensive measure that reflects the importance of each factor.

According to some embodiments of the present disclosure, based on the tenant-score, tenants may be further categorized through decision tree algorithm.

According to some embodiments of the present disclosure, the initial classification may organize tenant into structured groups based on their weights and associated attributes and may set the stage for detailed clustering.

According to some embodiments of the present disclosure, soft clustering technique clustering algorithm, such as Fuzzy C-Means and such as Gaussian Mixture Models may be applied to the classified groups. Tenants, such as tenants 110 in FIG. 1, may be grouped into overlapping clusters based on weighted attributes and proximity in feature space. The clustering technique ensures customers can belong to multiple groups with varying membership degrees, reflecting their diverse characteristics.

According to some embodiments of the present disclosure, the output of the clustering algorithm may be used to form finalized customer segments, which are well-defined and actionable for personalized business strategies. The final tenant segmentation results may be stored in a database, such as DynamoDB and may be used for forecasting, marketing, or service customization.

According to some embodiments of the present disclosure, weights may be assigned before the tenant segmentation. The inclusion of weights before clustering ensures that tenants are segmented based on their relative importance and contribution. Weighted scores create a data-driven foundation for segmentation.

According to some embodiments of the present disclosure, the tenant segmentation process which includes tenant-score, decision tree classification, and soft clustering technique clustering algorithm, such as Fuzzy C-Means and Gaussian Mixture Models may provide a precise and dynamic tenant segmentation.

According to some embodiments of the present disclosure, the dynamic implementation of adjusted forecasting algorithms in an application that is provided as a service, such as application 160 in FIG. 1, to tenants, in a multi-tenant cloud-based computing environment, may be automated to be executed every preconfigured period of time, for example every quarter.

According to some embodiments of the present disclosure, the automation of the process may be implemented by a monitoring and observability service such as AWS CloudWatch® or a serverless event bus service, such as EventBridge®. This approach provides a structured and segmentation pipeline, which is prioritizing tenants by relevance before applying clustering techniques.

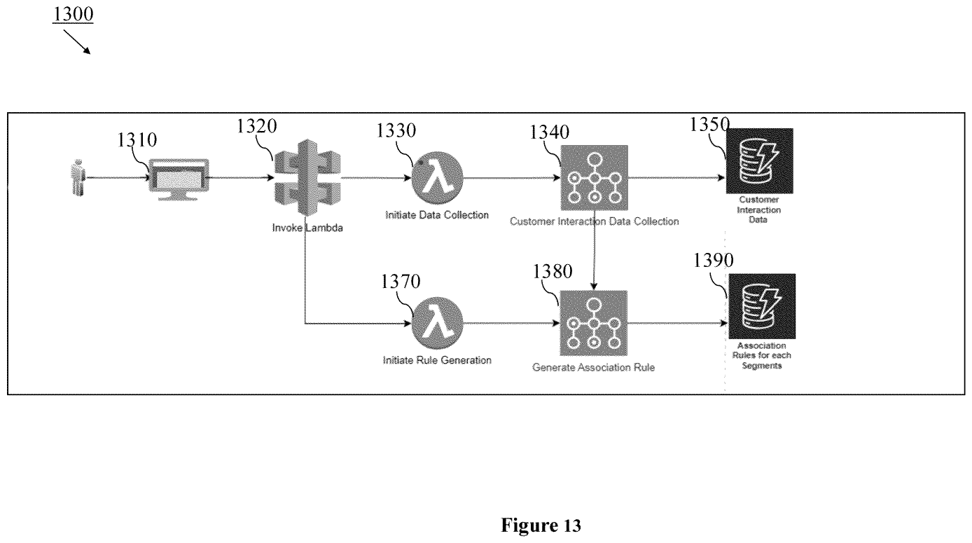

FIG. 13 is a high-level workflow 1300 of recommendation generation based on tenant-metadata and interactions data, in accordance with some embodiments of the present disclosure.

According to some embodiments of the present disclosure, in a system, such as system 100 in FIG. 1, the tenant interaction data collection may be operated by invoking Lambda 1320 after user selection for implementing adjusted forecasting algorithms in an application provided as a service to tenants 1310.

According to some embodiments of the present disclosure, after tenant segmentation, a Lambda function 1330 may be triggered from the Customer Experience (CX) platform to collect customer interaction data. This Lambda may fetch relevant forecasting details and channel preferences for each customer segment. After collecting tenant information such as domain, demography, tenant size clustering techniques may be applied which may segment tenants into various groups and this process would happen before collecting customer interaction data.

According to some embodiments of the present disclosure, a batch job may be executed for customer interaction data collection 1340, e.g. AWS batch, to gather to gather detailed customer interaction data, such as communication channels used and previous interaction history.

This interaction data is critical for refining customer segments further and is stored for subsequent rule generation. The customer interaction data is then saved for each tenant segment 1350.

According to some embodiments of the present disclosure, after data collection, another Lambda function may be triggered to initiate the generation of the association rules. The invoked Lambda may initiate a function for rule generation 1370. These rules are designed to uncover patterns or associations within the collected customer interaction data.

According to some embodiments of the present disclosure, an algorithm, such as Frequent Pattern Growth (FP-Growth) may be used to generate the association rules 1380 based on the collected data. The association rules for each tenant segment may be stored in an association database 1390. These association rules are provided to the LLM and used by it to predict future preferences and behaviors of customers.

According to some embodiments of the present disclosure, segmenting tenants based on their behavioral data and then generating actionable association rules may be used by the LLM for preference matching.

According to some embodiments of the present disclosure, tenants segments may be updated every preconfigured period of time, e.g., quarterly to ensure the tenant segmentation remains relevant to evolving customer behaviors. The rules generated based on tenant interactions data may be customized for each segment to ensure accurate preference matching.

According to some embodiments of the present disclosure, system 100 in FIG. 1 may be implemented by an architecture that combines AWS Lambda, AWS Batch, and Customer Experience (CX) platform to process large volumes of data and generate actionable insights for customer segmentation and rule-based personalization.

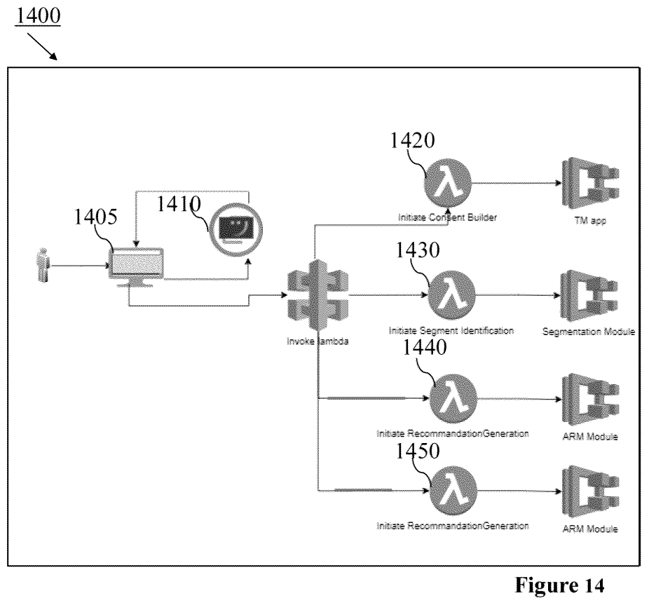

FIG. 14 is a high-level workflow 1400 of forecast recommendation generation based on tenant-metadata and interactions data, in accordance with some embodiments of the present disclosure.

According to some embodiments of the present disclosure, a user may interact with the Customer Experience (CX) platform 1405 by using a forecaster bot or an existing full-service, data-driven intelligent virtual agent such as enlighten autopilot 1410.

According to some embodiments of the present disclosure, the bot may gather tenant input, such as domain, preferences, demography, and interaction history, forming the base data for processing.

According to some embodiments of the present disclosure, the bot may identify tenant details and interactions, which may be used to extract tenant-metadata, such as preferences, domain, and previous interaction patterns. The extracted data may be stored and used to refine segmentation models and recommendations.

According to some embodiments of the present disclosure, a Lambda function, initiate consent builder 1420 may process tenant data for compliance and may store it in the tenant manager microservice which is used to gather all the tenant specific data. From the tenant manager application, data for segmentation, such as tenant size, service usage period, and the like may be retrieved. This ensures that the collected data complies with consent policies and is ready for segmentation or recommendation tasks.

According to some embodiments of the present disclosure, another Lambda function, initiate segment identification 1430 may be invoked to classify the tenant into predefined segments using the Segmentation Module. The Segmentation Module matches the customer's data with existing tenant segments and updates their classification as needed. These segments may provide the foundation for personalized recommendations.

According to some embodiments of the present disclosure, a Lambda function, initiate recommendation generation 1440 may be invoked to query the association rule mining module. The association rule mining module may use the rules generated from historical data to create relevant recommendations for the customer based on their interaction details and segment classification. The forecaster bot may forward the segment information to the association rule mining service, which may process the request and return a set of recommendations to the bot.

According to some embodiments of the present disclosure, a Lambda for recommendation generation 1450 may ensure that the tailored recommendations are validated and optimized using updated association rule mining rules. These refined recommendations are then forwarded back to the CX platform 1405 to be displayed to the tenant or automatically used in other workflows. The forecaster bot may send the recommendations to the configuration module of the application which may apply the recommended settings in the application and may update the forecaster bot.

According to some embodiments of the present disclosure, the automated forecast recommendation generation based on tenant-metadata and interactions data reduces latency in providing real-time recommendations to tenants as to forecasting algorithms used in the application provided as a service, channel preferences and other parameters.

According to some embodiments of the present disclosure, existing tenant segmentation data and association rules may be reused to personalize recommendations. Using AWS Lambda and serverless components may ensure that the architecture can scale with an increasing number of customer interactions.

According to some embodiments of the present disclosure, the optional inclusion of the consent builder may ensure that all recommendations align with tenant consent and privacy policies.

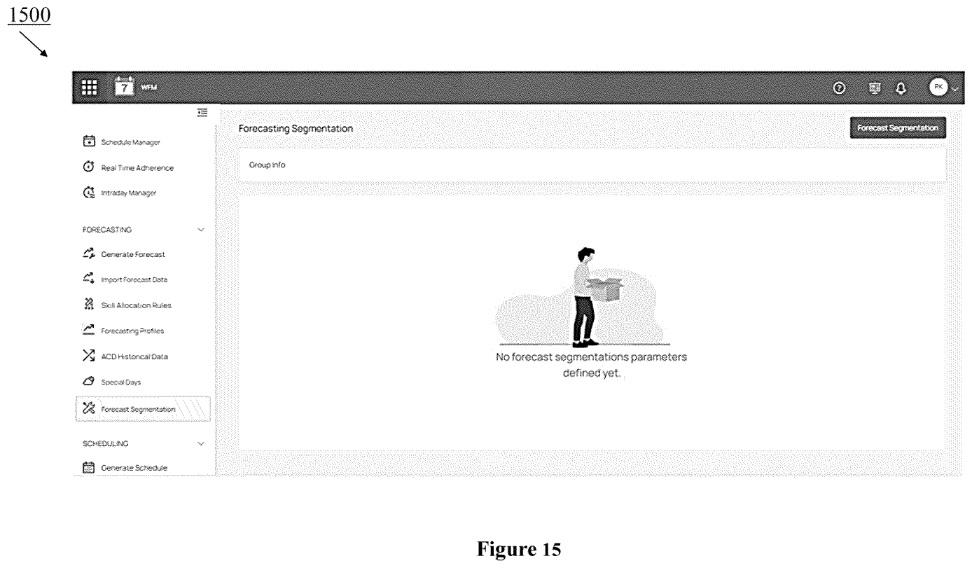

FIG. 15 is an example of a User Interface (UI) 1500 to define segmentation parameters, in accordance with some embodiments of the present disclosure.

According to some embodiments of the present disclosure, UI 1500 shows a situation where no segmentation parameter has been defined.

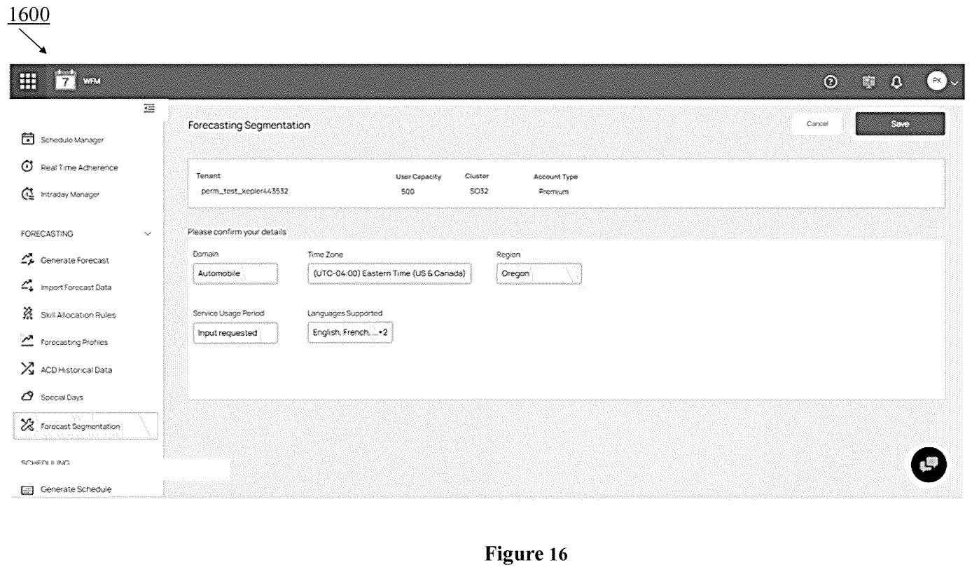

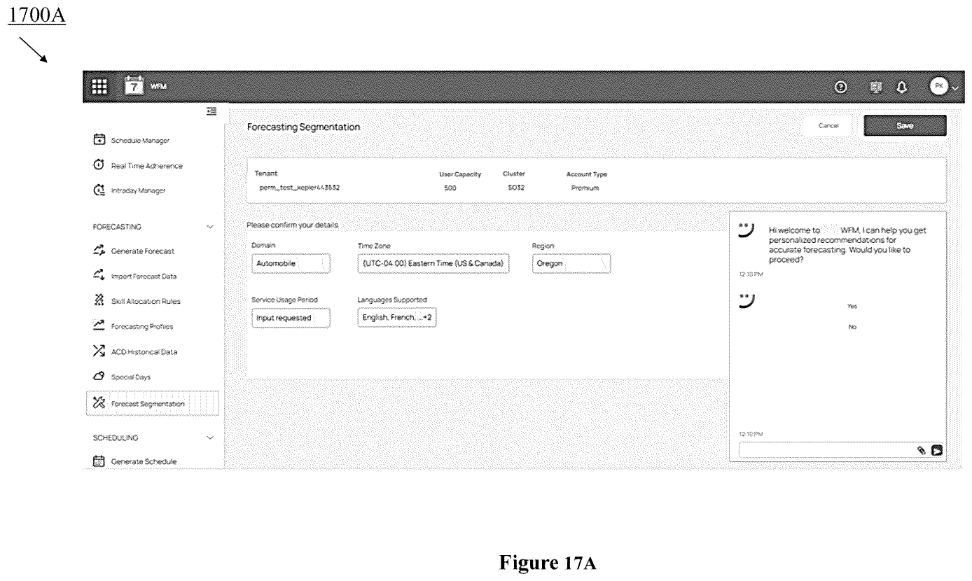

FIG. 16 is an example of a UI 1600 for forecasting segmentation, in accordance with some embodiments of the present disclosure.

According to some embodiments of the present disclosure, UI 1600 may be used to collect data for tenant segmentation process. The data for tenant segmentation e.g., tenant-metadata, may be entered by users, such as tenant information, user capacity, cluster, account type, domain, time zone, region, service usage period, and supported languages.

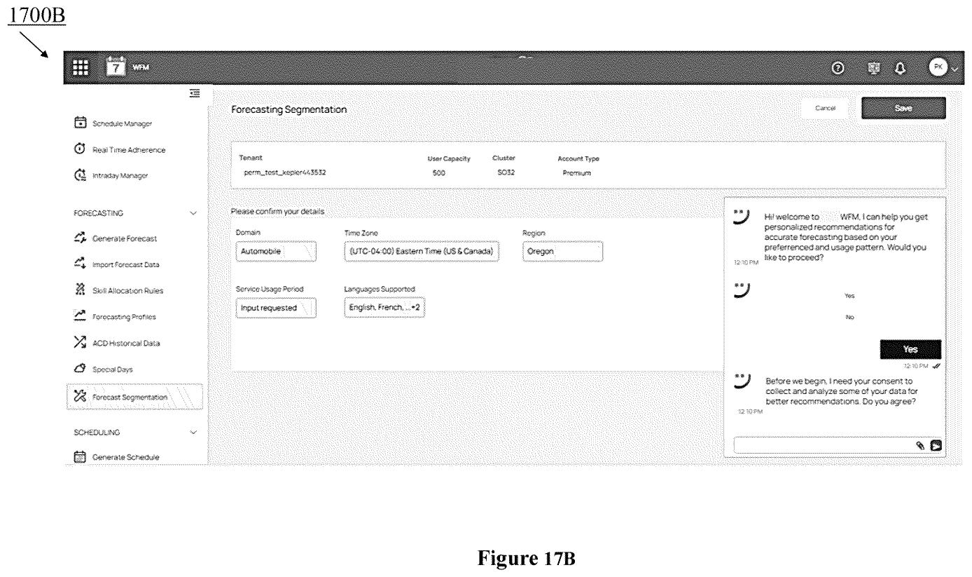

FIG. 17A-17B are examples 1700A-1700B of UIs to interact via bot conversation to enhance forecasting segmentation, in accordance with some embodiments of the present disclosure.

According to some embodiments of the present disclosure, a conversational bot may guide the user through the tenant segmentation process. The bot may provide context, explains options, and collects user consent before proceeding. This interaction via the UI makes the process intuitive and reduces the learning curve for users.

According to some embodiments of the present disclosure, after the user provides consent, the bot continues to assist by collecting additional data required for accurate segmentation and forecasting. The optional conversational design ensures clarity and user engagement.

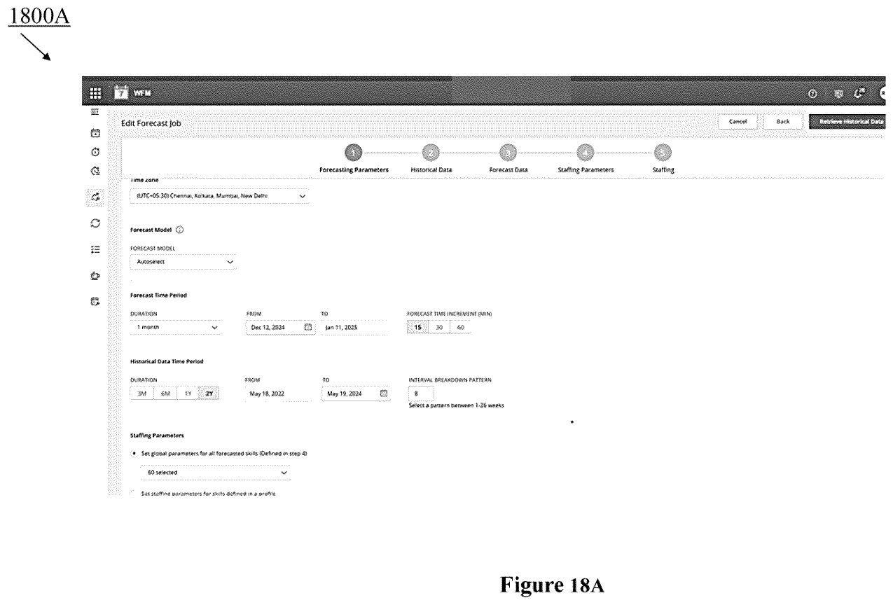

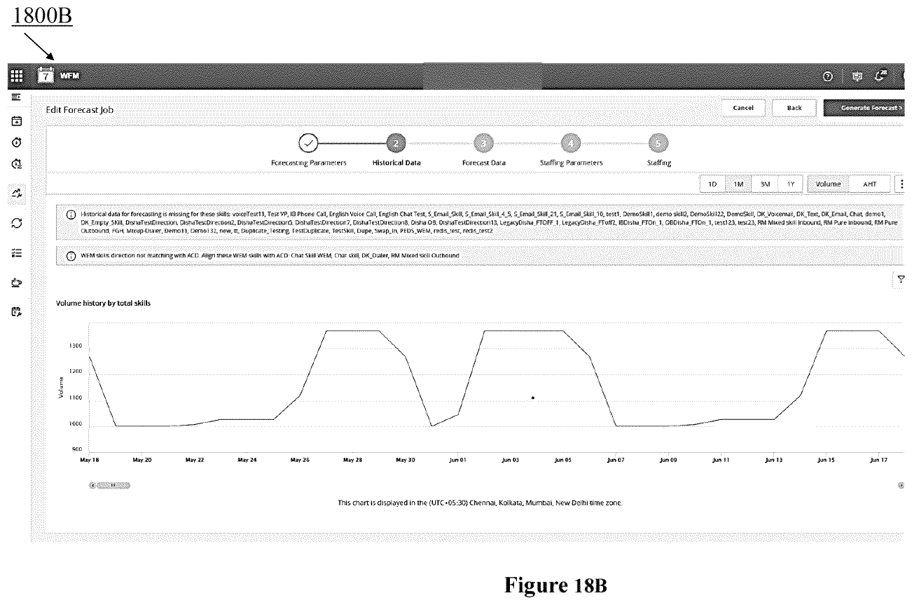

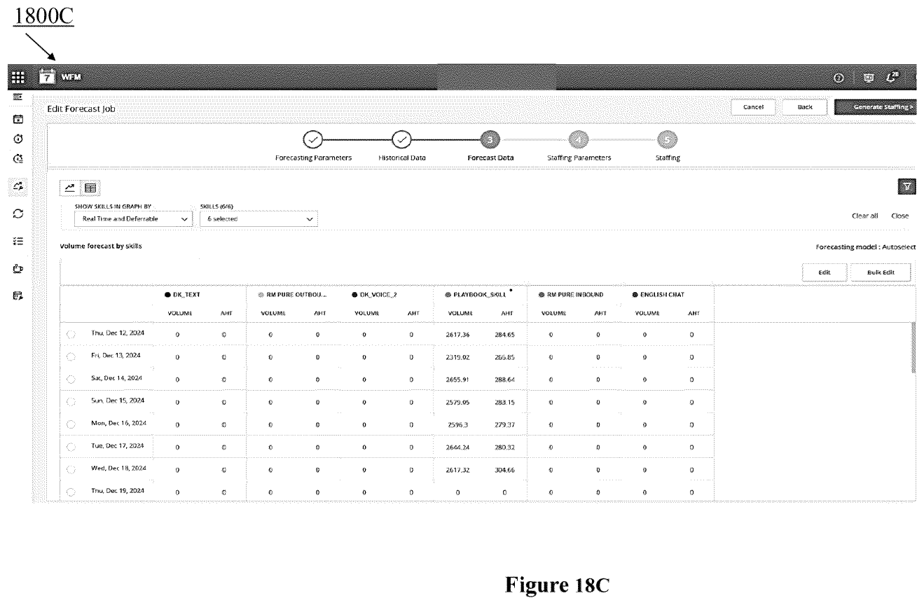

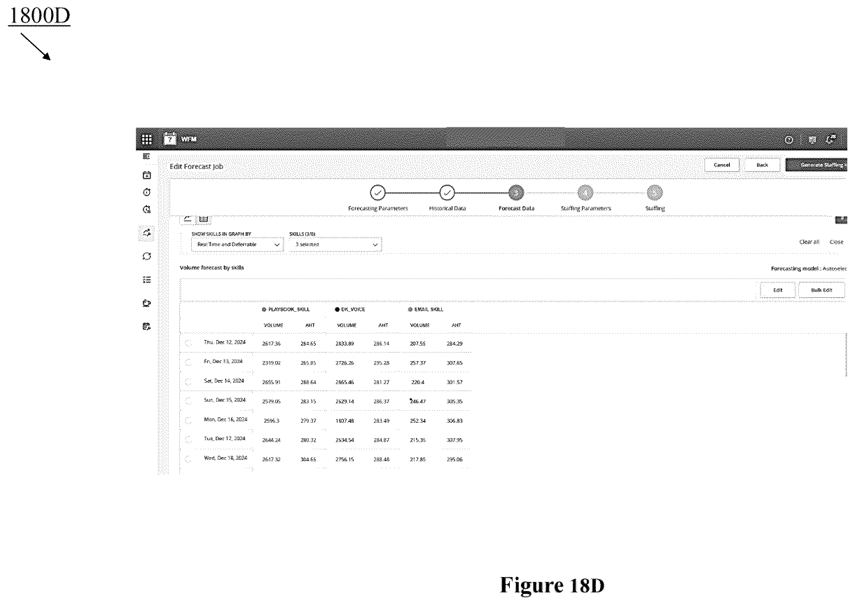

FIGS. 18A-18D is an example of forecasting without tenant segmentation and with tenant segmentation, according to some embodiments of the present disclosure.

According to some embodiments of the present disclosure, FIG. 18A shows that without tenant segmentation, customers may struggle to identify which skills data should be considered for forecasting, and which parameters are most relevant for generating accurate forecasts. This lack of guidance could lead to the generation of inaccurate forecasts and increased trial-and-error work by the user in testing different forecasting parameters, as shown in FIG. 18B-18C. However, with tenant segmentation, as shown in FIG. 18D tenants may have a notion of their grouping in advance, along with the preferred forecasting algorithms and channels specific to their segment. By knowing their group's characteristics, users can select the most appropriate forecasting parameters, ensuring more accurate forecasts with less manual intervention and better alignment with their requirements.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-system for dynamically implementing adjusted forecasting algorithms in an application provided as a service to tenants, in a multi-tenant cloud-based computing environment, said computerized-system comprising:
a tenant-metadata database;
an interactions data database;
an association rules database;
a memory to store the plurality of databases; and
one or more processors, said one or more processors are configured to:
(i) collect tenant-metadata and interactions data from each tenant in the multi-tenant cloud-based computing environment;
(ii) store the tenant-metadata collected from each tenant in the tenant-metadata database and the interactions data in the interactions data database;
(iii) operate tenant segmentation based on a calculated tenant-score and the stored interactions data to yield one or more tenant-segments;
(iv) for each tenant-segment in the one or more tenant-segments:
a. retrieve channel information and forecast parameters related to tenants in the tenant-segment from the interactions data database;
b. invoke a serverless compute service to initiate rule association generation with a data mining algorithm based on the retrieved interactions data to yield association rules;
c. store the association rules in the association rules database;
d. provide the stored association rules, the interaction data and the tenant-metadata to a Large Language Model (LLM) and configure the LLM to interact with the association rules database based on the tenant-metadata;
e. receive from the LLM forecasting algorithms, channel preferences, and other parameters; and
f. implement the received forecasting algorithms, channel preferences, and other parameters in the application provided as a service for each tenant in the tenant-segment; and
(v) repeat operations (i)-(iv) every preconfigured period of time to adapt to changing tenant-score and requirements.

2. The computerized-system of claim 1, wherein the tenant-score is calculated based on periodically updated one or more parameters and related weights, and
wherein the periodically updated one or more parameters are at least one of: (i) demographics; (ii) preferences; (iii) service usage; (iv) domain; (v) license type; and (vi) tenant size.

3. The computerized-system of claim 1, wherein the application is a Workforce Management (WFM) application that is used for staff forecasting and scheduling in a contact center and the other parameters are staffing parameters.

4. The computerized-system of claim 1, wherein the collecting of tenant-metadata and interactions data further comprising data preprocessing of the collected tenant-metadata and interactions data.

5. The computerized-system of claim 1, wherein said operating of tenant segmentation comprising:
(i) grouping the tenants based on domain and demographic data by using decision tree classification algorithm to yield one or more groups; and
(ii) applying a soft clustering technique clustering algorithm on the one or more groups to cluster tenants based on one or more parameters to yield the one or more tenant-segments.

6. The computerized-system of claim 1, wherein when said application is provided for a new tenant, said one or more processors are further configured to associate the new tenant to the tenant-segment in the one or more tenant-segments based on the tenant-score.

7. The computerized-system of claim 5, wherein the soft clustering technique clustering algorithm is one of: Fuzzy C-Means and Gaussian Mixture Models.

8. The computerized-system of claim 1, wherein the data mining algorithm is Frequent Pattern growth (FP-growth).

9. A computerized-method for dynamically implementing adjusted forecasting algorithms used in an application provided as a service to tenants, in a multi-tenant cloud-based computing environment, said computerized-method comprising:
(i) collecting tenant-metadata and interactions data from each tenant in the multi-tenant cloud-based computing environment;
(ii) storing the tenant-metadata collected from each tenant in a tenant-metadata database and the interactions data in an interactions data database;
(iii) operating tenant segmentation based on a calculated tenant-score and the stored interaction data to yield one or more tenant-segments;
(iv) for each tenant-segment in the one or more tenant-segments:
a. retrieving channel information and forecast parameters related to tenants in the tenant-segment from the interactions data database;
b. invoking a serverless compute service to initiate rule association generation with a data mining algorithm based on the retrieved interactions data to yield association rules;
c. storing the association rules in the association rules database;
d. providing the stored association rules, the interaction data and the tenant-metadata to a Large Language Model (LLM) and configuring the LLM to interact with the association rules database based on the tenant-metadata;
e. receiving from the LLM forecasting algorithms, channel preferences, and other parameters; and
f. implementing the received forecasting algorithms, channel preferences, and other parameters in the application provided as a service for each tenant in the tenant-segment; and
(v) repeating operations (i)-(iv) every preconfigured period of time to adapt to changing tenant-score and requirements.
